(19) United States
(12) Patent Application Publication
(10) Pub. No.: US 2004/0158058 A1
(43) Pub. Date: Aug. 12, 2004

(54) Soluble, associative carboxymethylcellulose, method of making, and uses thereof

(76) Inventors: Mary Jean Cash, Wilmington, DE (US); Patrick J. Cowan, Hockessin, DE (US); Gijsbert Kroon, Giessendam (NL)

Correspondence Address: Hercules Incorporated, Hercules Plaza, 1313 N. Market Street, Wilmington, DE, 19894-0001, US

(21) Appl. No.: 10/722,888

(22) Filed: Nov. 26, 2003

Related U.S. Application Data
(60) Provisional application No. 60/429,291, filed on Nov. 26, 2002.

(51) Int. Cl. C08B 11/12

(52) U.S. Cl. 536/98

(57) ABSTRACT

A water-soluble, associative carboxymethylcellulose (CMC) exhibits unique and highly desirable rheology and performance properties in a wide variety end-use systems. This unique CMC is prepared in a novel staging process. The end-use systems include personal care, household care, paint, building material and construction, pharmaceutical, medical care, oilfield, mineral processing, paper making and paper coating, and food.

### FIELD OF INVENTION

The present invention relates to water-soluble carboxymethylcelluloses (CMCs) that exhibit unique and highly desirable rheology and performance in end use systems and to a process for the preparation thereof. The CMCs of the present invention exhibit associative behavior both in neat solutions and in filled systems. The association is shear reversible, which enhances utility.

### BACKGROUND OF THE INVENTION

Carboxymethylcellulose (CMC) is one of the most versatile and widely used cellulose ethers as a component for aqueous systems. It may act as a suspending agent, thickening agent, protective colloid, humectant, and for the control of crystallization of some other components. CMC is physiologically inert and is an anionic polyelectrolyte. The above noted characteristics makes CMC suitable for use in a wide spectrum of applications in the food, pharmaceutical, personal care, paper, building materials and construction, oilfield, and other industries.

There are many types of commercial CMCs available varying with respect to average degree of polymerization and substitution. The chemical and physical properties of the CMCs depend not only on the average degree of polymerization and substitution, but also on the overall solubility of the CMC as well as the distribution of carbomethoxy substituents along the cellulose chains. Both smoothly and blocky substituted CMCs are well known in the art. Blocky CMCs can be produced by lowering DS and/or changing the manufacturing process. However, processes that target a blocky CMC produce CMCs with limited solubility. In many cases a substantial portion of the CMC forms a swollen gel in aqueous applications. Such gels are undesirable in many applications, such as toothpaste, where the gel structure imparts an undesirable gel appearance in the toothpaste.

U.S. Pat. No. Re 32,976 discloses a smoothly substituted, enzyme and salt resistant CMC which is prepared using an etherification agent which comprises at least 50% isopropyl monochloroacetate. Smoothly substituted CMCs will not provide the associative properties of the current invention. The CMCs of the present invention are prepared from monochloroacetic acid or sodium chloroacetate, not isopropyl monochloroacetate.

U.S. Pat. No. 4,579,943 discloses a CMC that has high liquid absorbing property that is derived from regenerated cellulose, having cellulose II form. The CMCs are of relatively low DS (0.1-0.64) and are substantially insoluble in water. The CMCs of the current invention are derived from cellulose I, not cellulose II or regenerated cellulose.

Publication WO 99/20657 discloses a CMC that has a tan delta of less than 1.0 at a concentration of 0.5% under specific testing conditions. The CMC of the current invention do not have a tan delta less than 1.0 at 0.5% concentration.

The publication by G. Mann, J. Kunze, F. Loth and H-P fink of Fraunhofer Institut fur Angewandte Polymerforschung entitled “Cellulose ethers with a Block-like Distribution of the Substituents by Structure-selective Derivatization of Cellulose”, Polymer, vol. 39, No. 14, pp. 3155-3165, Published 1998, discloses the preparation and testing of block-like distribution of CMC. The CMC is prepared by a step-by-step etherification reaction where a systematic carboxymethylation in alcohol-water medium is conducted while maintaining a low NaOH concentration (NaOH/AGU molar ratio<0.6). The alkali cellulose is formed at elevated temperatures (50-70° C.). It is reported that this process produces block-like cellulose ethers, including CMC, or cellulose etheresters with alternating hydrophilic and hydrophobic as well as various ionic chain segments. The CMCs are swollen particles in water and are not substantially soluble. The CMCs of the present invention are produced at higher NaOH/AGU ratios (about 1.1 to about 1.9) and low alkali cellulose temperatures (20-30° C.), and are substantially soluble in water.

There is still a need for an associative, thixotropic CMC that exhibits associative behavior both in neat solutions and in filled systems. The association would be shear reversible, which would enhance utility. Such rheology would provide high thickening efficiency, and stabilize emulsions and suspensions, yet allow processing advantages such as ease of pumping or spreading, due to the reversible shear thinning characteristics of the associative network.

### SUMMARY OF THE INVENTION

The present invention is related to a composition comprising CMC having a relative urea/water ratio of less than about 0.9. The relative urea ratio is defined as:

$$\begin{matrix}\begin{matrix}Relative Viscosity \\ in 6 M Urea\end{matrix} = \frac{\begin{matrix}Dynamic Viscosity of \\ 1 \% CMC in 6 M urea\end{matrix}}{6 M urea viscosity} = \frac{\begin{matrix}Dynamic Viscosity of \\ 1 \% CMC in 6 M urea\end{matrix}}{1.4 cP} \\ \begin{matrix}Relative Viscosity \\ in Water\end{matrix} = \frac{\begin{matrix}Dynamic Viscosity of \\ 1 \% CMC in Water\end{matrix}}{Water viscosity} = \frac{\begin{matrix}Dynamic Viscosity of \\ 1 \% CMC in 6 M urea\end{matrix}}{0.89 cP} \\ Relative Urea \text{/} Water Ratio = \frac{Relative Viscosity in 6 M Urea}{Relative Viscosity in Water}\end{matrix}$$

This invention is also directed to a process for making a CMC comprising a) reacting in an aqueous slurry of isopropyl alcohol, a source of cellulose, and about 50-80% of the stoichiometric level of alkali for a sufficient time and at a sufficient temperature to form an alkali cellulose b) adding sufficient alkali to bring the total alkali concentration to stoichiometric levels, followed by addition of the requisite amount of etherification agent, c) completing the etherification reaction and optionally, d) adjusting final molecular weight/viscosity by addition of oxidizing agents capable of degrading cellulosic chains.

This invention also comprehends the use of the CMC of the present invention in an aqueous rheology modifier system as a vehicle component of a personal care, household care, plaint, building material, construction, pharmaceutical, oilfield, food, paper making or paper coating composition.

### BRIEF DESCRIPTION OF DRAWINGS

FIG. 1 shows a graph of toothpaste viscosity over time.

FIG. 2 shows a graph of toothpaste viscosity overtime that has been normalized.

FIG. 3 shows a graph of toothpaste structure over time.

FIG. 4 shows a graph of toothpaste structure over time that has been normalized.

FIG. 5 shows a graph of crushing strengths of blends of polymers.

FIG. 6 shows a graph of percent drug dissolved over time.

FIG. 7 shows a graph of percent drug dissolved over time.

### DETAILED DESCRIPTION OF THE INVENTION

A CMC has been surprisingly discovered that exhibits unique and highly desirable rheology and performance properties in end use systems.

In accordance with the present invention, the viscosity builds up not only by means conventional to CMC, but also is boosted significantly by molecular association. The association leads to network formation and gel-like rheological properties. The fact that the association is shear reversible enhances utility.

The CMCs of the present invention have been shown to lower the CMC use level needed and to provide rheology attributes unique from other CMCs available today. The unique rheology provides high thickening efficiency, and stabilizes emulsions and suspensions. The CMCs of the present invention provide significantly enhanced performance over known CMCs in aqueous systems including personal care formulations (e.g., toothpaste, skin care, and hair care), medical care (e.g., wound care and ostomy,), food applications (i.e., tortillas, cake mixes, bread mixes, bread, ice cream, sour cream, pasteurized processed cheese spreads, and cheese foods), beverages (i.e., instant cold/hot drinks, ready to drink beverages, and fruit flavored drinks), paint systems, building and construction materials (such as joint formulations), mineral processing, oil field formulations (e.g., drilling fluids), paper making and paper coating formulations, household formulations (e.g., laundry detergents, fabric softeners), and pharmaceutical formulations.

In accordance with the present invention, when the composition is a personal care composition, it includes (a) from about 0.1% to about 99.0% by weight of the vehicle component and (b) at least one active personal care ingredient. Examples of the at least one active personal care ingredient are deodorant, skin coolants, emollients, antiperspirant actives, moisturizing agents, cleansing agents, sunscreen actives, hair treatment agents, oral care agents, tissue paper products, and beauty aids.

In accordance with the present invention, the composition is a household care composition, it includes (a) from about 0.1% to about 99.0% by weight of the vehicle component and (b) at least one active household care ingredient. Examples of the at least one active household care ingredient are industrial grade bar, gel and liquid soap actives, all purpose cleaning agents, disinfecting ingredient, rug and upholstery cleaning actives, laundry softeners actives, laundry detergent ingredients, dishwashing detergents, toilet bowl cleaning agents and fabric sizing agents.

In addition to the ingredients conventionally used in the personal care and household care, the composition according to the present invention can optionally also include ingredients such as a colorant, preservative, antioxidant, nutritional supplements, activity enhancer, emulsifiers, viscosifying agents (such as salts, i.e., NaCl, NH₄Cl & KCl, water-soluble polymers, i.e., hydroxyethylcellulose, and fatty alcohols, i.e., cetyl alcohol), alcohols having 1-6 carbons, and fats and oils.

The CMCs may also be used in combination with other known rheology modifiers including, but not limited to, polysaccharides (e.g., carrageenan, guar, hyaluronic acid, glucosaminoglycan, hydroxyethyl cellulose, hydrophobically modified hydroxyethyl cellulose, ethyl hydroxyethyl cellulose, hydroxypropyl methylcellulose, hydroxyethyl methylcellulose, methylcellulose, cationic guar, carbomer), biopolymers (e.g., xanthan), synthetic polymers (polyethylene glycol, polyvinylacetate, chlorohexidiene), and thickening silicas.

The use of CMC in toothpaste formulations is well known in the toothpaste industry as a binder system for toothpaste that gives the toothpaste a desirable high structure. The binder system includes CMC types with other polysaccharides, inorganic salts, chelating agents and combinations thereof.

Commercially available CMC types vary in the degree of structure they provide to the toothpaste. Highly thixotropic grades of CMC tend to render toothpaste of higher structure. These thixotropic CMC types also tend to contribute to greater post-thickening.

Cellulose gum (CMC) alone has been a traditional binder for toothpaste. In toothpaste, CMC provides viscosity, stand-up or structure, and syneresis control. Toothpaste made with CMC is also known to have a slow rate in viscosity build up over the shelf life of the toothpaste thus not reaching a stable viscosity until after first 30 days or more. This is also called “post-thickening”.

Other binders commonly used in toothpaste are carrageenan or carrageenan and xanthan together. Carrageenan and xanthan provide good stand-up, viscosity and syneresis control; however, they tend to be more expensive alternatives as compared to CMC. Toothpaste made with carrageenan and xanthan tend to exhibit a stable viscosity rather quickly after processing and little post-thickening.

In accordance with the present invention, the CMC of the present invention can be use either alone or in combination with other polysaccharides, synthetic polymers and or salts and provide high efficiencies and enhanced performance. See the toothpaste Examples hereinafter for the demonstration of the unexpected results of the present invention.

Use of the CMCs of the present invention have allowed a use level reduction of about 40% while maintaining critical toothpaste properties such as stand-up, gloss and syneresis control. The lower use levels and/or shear thinning behavior of the CMCs may offer additional advantages to toothpaste properties such as improved flavor release, improved actives delivery, improved fluoride delivery, higher gloss, improved extrudability from the tube, and improved anti-microbial effectiveness. Potential improvements to the toothpaste manufacturing process include, but are not limited to, reduction of entrapped air during manufacturing process, improvements in mixing operations, and improvements in extrusion into tubes.

Water-based protective coating compositions (commonly referred to as paints) in which cellulose ether derivatives are conventionally used include latex paints or dispersion paints, of which the principal ingredients are film-forming lattices such as styrenebutadiene copolymers, vinyl acetate polymers and copolymers, and acrylic polymers and copolymers. Typically, they also contain opacifying pigments, dispersing agents and water-soluble protective colloids, the proportions being, by weight of the total composition, about 10 parts to about 50 parts of a latex, about 10 parts to about 50 parts of an opacifying pigment, about 0.1 part to about 2 parts of a dispersing agent, and about 0.1 part to about 2 parts of a water-soluble protective colloid.

Water soluble protective colloids conventionally used in the manufacture of latex paints (to stabilize the lattices and maintain the wet edge of a painted area longer in use) include casein, methyl cellulose, hydroxyethylcellulose (HEC), sodium carboxymethyl cellulose (CMC), polyvinyl alcohol, starch, and sodium polyacrylate. The disadvantages of the natural based cellulose ethers are that they may be susceptible to biological degradation and frequently impart poor flow and leveling properties, while the synthetic materials such as polyvinyl alcohol often lack enough thickening efficiency to maintain sag resistance. The thickening efficiency of the cellulose ethers is usually improved by increasing their molecular weight which normally is more expensive.

In accordance with the present invention, the CMC of the present invention can be used in lower amounts in paints and provide unexpected high quality results. This is illustrated in the working Examples hereinafter.

The CMCs of the present invention are prepared using conventional slurry process methods. For example, isopropyl alcohol, water, and about 50-80% of the stoichiometric amount of NaOH are reacted with cellulose at a temperature of about 20° C. for a sufficient time to produce alkali cellulose, about 1.5 hours. Sufficient NaOH is added to bring the total NaOH level to or slightly above stoichiometric levels and monochloroacetic acid is added shortly after the second NaOH addition. The reaction conditions are normally to raise the temperature to about 70° C. for about one to two hours to effect etherification. The molecular weight and viscosity of the CMC can be adjusted (reduced) by addition of an oxidizing agent, such as hydrogen peroxide, subsequent to etherification. The reaction mass is then optionally cooled, excess base neutralized, if necessary, and the product is washed. This product can then be dried and ground. The critical feature of this invention is that the amount of alkali utilized to effect etherification is less than stoichiometric and that the remaining alkali is added just prior to the etherification agent. The degree of substitution of the CMC is about 0.6 to about 1.2.

In accordance with the present invention, the CMC can be differentiated from prior art CMCs by their being substantially soluble in aqueous media environments and their behavior in environments that do not favor association. It is a known fact that urea breaks up association by breaking hydrogen bonds. The subject CMCs exhibit a viscosity decrease in the presence of urea, as determined by the relative urea ratio. The relative urea ratio is defined as:

$$\begin{matrix}\begin{matrix}Relative Viscosity \\ in 6 M Urea\end{matrix} = \frac{\begin{matrix}Dynamic Viscosity of \\ 1 \% CMC in 6 M urea\end{matrix}}{6 M urea viscosity} = \frac{\begin{matrix}Dynamic Viscosity of \\ 1 \% CMC in 6 M urea\end{matrix}}{1.4 cP} \\ \begin{matrix}Relative Viscosity \\ in Water\end{matrix} = \frac{\begin{matrix}Dynamic Viscosity of \\ 1 \% CMC in Water\end{matrix}}{Water viscosity} = \frac{\begin{matrix}Dynamic Viscosity of \\ 1 \% CMC in 6 M urea\end{matrix}}{0.89 cP} \\ Relative Urea \text{/} Water Ratio = \frac{Relative Viscosity in 6 M Urea}{Relative Viscosity in Water}\end{matrix}$$

### EXAMPLES

The following examples are merely set forth for illustrative purposes, but it is to be understood that other modifications of the present invention within the skill of an artisan in the related industry can be made without departing from the spirit and scope of the invention. All percentages and parts are by weight unless specifically stated otherwise.

### Example 1

Isopropyl alcohol (IPA, 696.67 g) and deionized (DI) water (76.945 g) were charged into a jacketed resin kettle reactor equipped with an air driven stirrer, stainless steel agitator, a pressure equalizing addition funnel, a reflux condenser, vacuum, nitrogen inlet and a thermocouple. A cellulose pulp (65.0 g, 6.4% moisture) was added to the reactor, the reactor was sealed, and the agitator was adjusted to obtain good mixing. The reactor was inerted and the mixture was cooled to 20° C.

Aqueous NaOH (50%, 60.92 g) was slowly added to the reactor through the addition funnel, maintaining the mixture slurry temperature at 20° C. The reaction mixture was held for 1 hour at 20° C. after the caustic addition was completed.

Aqueous NaOH (50%, 16.02 g) was slowly added to the reactor through the addition funnel, maintaining the mixture slurry temperature at 20° C. The reaction mixture was held for 5 minutes at 20° C. after the caustic addition was completed. Monochloroacetic acid (MCA, 42.91 g) was added to the reactor through an open reactor port, maintaining a reactor slurry temperature of 20° C. After MCA addition was completed, the reaction slurry was heated to 70° C. and held for 1.5 hours. The reaction slurry was filtered and the resulting wet cake was washed three times with 565 g of 80% aqueous methanol and one time with 1000 g of pure methanol. The resulting wet cake was broken into small particles and dried in a fluidized bed dryer for 35 minutes. (Air-dry for 5 minutes, heat-dry at 50° C. for 10 minutes, and heat-dry at 70° C. for an additional 20 minutes.) The product was ground in Retsch Grinding Mill using a 1 mm screen. Degree of Substitution (DS)=0.89

### Example 2

Isopropyl alcohol (IPA, 696.67 g) and deionized (DI) water (76.945 g) were charged into a jacketed resin kettle reactor equipped with an air driven stirrer, stainless steel agitator, a pressure equalizing addition funnel, a reflux condenser, vacuum, nitrogen inlet and a thermocouple. A cellulose pulp (65.0 g, 6.4% moisture) was added to the reactor, the reactor was sealed, and the agitator was adjusted to obtain good mixing. The reactor was inerted and the mixture was cooled to 20° C.

Aqueous NaOH (50%, 60.92 g) was slowly added to the reactor through the addition funnel, maintaining the mixture slurry temperature at 20° C. The reaction mixture was held for 1 hour at 20° C. after the caustic addition was completed.

Aqueous NaOH (50%, 16.02 g) was slowly added to the reactor through the addition funnel, maintaining the mixture slurry temperature at 20° C. The reaction mixture was held for 5 minutes at 20° C. after the caustic addition was completed. Monochloroacetic acid (MCA, 42.91 g) was added to the reactor through an open reactor port, maintaining a reactor slurry temperature of 20° C. After MCA addition was completed, the reaction slurry was heated to 70° C. and held for 1.5 hours. 1.6 ml of 6% H₂O₂ was added to the reactor and the slurry was heated at 70° C. for 30 minutes. The reaction slurry was filtered and the resulting wet cake was washed three times with 565 g of 80% aqueous methanol and one time with 100 g of pure methanol. The resulting wet cake was broken into small particles and dried in a fluidized bed dryer for 35 minutes. (Air-dry for 5 minutes, heat-dry at 50° C. for 10 minutes, and heat-dry at 70° C. for an additional 20 minutes.) The product was ground in Retsch Grinding Mill using a 1 mm screen. Degree of Substitution (DS)=0.87.

### Example 3

Isopropyl alcohol (IPA, 123.4 gallons), water (130.3 lbs), methanol (6.36 gallons), and NaOH (flake, 35.4 lbs.) were charged into the reactor. The reactor was inerted and the caustic/solvent mix was cooled to about 20° C., at which time a cellulose pulp (108 lbs, 4% moisture) was added to the reactor. The agitation was adjusted to give good mixing in the slurry and the slurry was recooled to about 20° C. The reaction slurry was held for 1 hour at 20° C.

Aqueous NaOH (50%, 58.7 lbs.) was added to the reactor and the reaction mixture was held for 15 minutes at 20° C. after the caustic addition was completed. Monochloroacetic acid (MCA, 70.5 lbs.). IPA (9.0 gallons), dichloroacetic acid (DCA, 926.8 g) and acetic acid (79.9 g) were added to the reactor, maintaining a reactor slurry temperature of 20° C. After MCA addition was completed, the reaction slurry was heated to 70° C. and held for 1 hour. 282 g of 18% H₂O₂ was added to the reactor and the slurry was heated at 70° C. for 60 minutes.

The reaction slurry was centrifuged and the wet cake was washed with three times with 300 gallons of 80% methanol and two times with 300 gallons 100% methanol. The material was dried in an Abbe dryer under vacuum at 80-90° C. to a moisture content of 4-6%. The product was ground in a micropulverizer through a 0.0278 inch screen. Degree of Substitution (DS)=0.79.

### Example 4

The conditions of Example 3 were repeated. DS=0.78

### Example 5

Isopropyl alcohol (IPA, 121.9 gallons), water (130.0 lbs), methanol (6.29 gallons), and NaOH (flake 45.6 lbs.) were charged into the reactor. The reactor was inerted and the caustic/solvent mix was cooled to about 20° C., at which time a cellulose pulp (108 lbs, 4% moisture) was added to the reactor. The agitation was adjusted to give good mixing in the slurry and the slurry was recooled to about 20° C. The reaction slurry was held for 1 hour at 20° C.

Aqueous NaOH (50%, 58.7 lbs.) was added to the reactor and the reaction mixture was held for 15 minutes at 20° C. after the caustic addition was completed. Monochloroacetic acid (MCA, 81.0 lbs.). IPA (9.0 gallons), dichloroacetic acid (DCA, 1065.9 g) and acetic acid (91.9 g) were added to the reactor, maintaining a reactor slurry temperature of 20° C. After MCA addition was completed, the reaction slurry was heated to 70° C. and held for 1 hour. 188 g of 18% H₂O₂ was added to the reactor and the slurry was heated at 70° C. for 60 minutes.

The reaction slurry was centrifuged and the wet cake was washed with three times with 300 gallons of 80% methanol and two times with 300 gallons 100% methanol. The material was dried in an Abbe dryer under vacuum at 80-90° C. to a moisture content of 4-6%. The product was ground in a micropulverizer through a 0.0278 inch screen. Degree of Substitution (DS)=0.86.

### Example 6

The conditions of Example 5 were repeated. DS=0.86

### Example 7

Isopropyl alcohol (IPA, 121.1 gallons), water (146.0 lbs), methanol (6.24 gallons), and NaOH (flake, 35.4 lbs.) were charged into the reactor. The reactor was inerted and the caustic/solvent mix was cooled to about 20° C., at which time a cellulose pulp (108 lbs, 4% moisture) was added to the reactor. The agitation was adjusted to give good mixing in the slurry and the slurry was recooled to about 20° C. The reaction slurry was held for 1 hour at 20° C.

Aqueous NaOH (50%, 58.7 lbs.) was added to the reactor and the reaction mixture was held for 15 minutes at 20° C. after the caustic addition was completed. Monochloroacetic acid (MCA, 70.5 lbs.). IPA (9.0 gallons), dichloroacetic acid (DCA, 926.8 g) and acetic acid (79.9 g) were added to the reactor, maintaining a reactor slurry temperature of 20° C. After MCA addition was completed, the reaction slurry was heated to 70° C. and held for 1 hour. 282 g of 18% H₂O₂ was added to the reactor and the slurry was heated at 70° C. for 60 minutes.

The reaction slurry was centrifuged and the wet cake was washed with three times with 300 gallons of 80% methanol and two times with 300 gallons 100% methanol. The material was dried in an Abbe dryer under vacuum at 80-90° C. to a moisture content of 4-6%. The product was ground in a micropulverizer through a 0.0278 inch screen. Degree of Substitution (DS)=0.79.

### Example 8

Isopropyl alcohol (IPA, 14 kg), water (2184 g), methanol (728.8 g), were charged into the reactor. The reactor was inerted and the solvent mix was cooled to about 20° C., at which time a cellulose pulp (1800 g, 3.6% moisture) was added to the reactor. The agitation was adjusted to give good mixing in the slurry, the slurry was recooled to about 20° C., and NaOH (flake, 691.4 g) was added to the reactor. The reaction slurry was held for 1 hour at 20° C.

Aqueous NaOH (50%, 353.6 g) was added to the reactor and the reaction mixture was held for 15 minutes at 20° C. after the caustic addition was completed. Monochloroacetic acid (MCA, 939.8 g). IPA (977 g), dichloroacetic acid (DCA, 27.3 g) and acetic acid (2.4 g) were added to the reactor, maintaining a reactor slurry temperature of 20° C. After MCA addition was completed, the reaction slurry was heated to 70° C. and held for 1 hour.

The reaction slurry was filtered, and the resulting wet cake was washed three times with 12 gallons of 80% aqueous methanol, and one time with 12 gallons of 95% methanol. The material was dried in a vacuum tray dryer at 70° C. to a final moisture content of 4-6%. The dried product was ground in a micropulverizer through a 0.0278 inch screen. Degree of Substitution=0.73.

### Example 9

Isopropyl alcohol (IPA, 696.67 g) and deionized (DI) water (76.95 g) were charged into a jacketed resin kettle reactor equipped with an air driven stirrer, stainless steel agitator, a pressure equalizing addition funnel, a reflux condenser, vacuum, nitrogen inlet and a thermocouple. A cellulose pulp (65.0 g, 6.8% moisture) was added to the reactor, the reactor was sealed, and the agitator was adjusted to obtain good mixing. The reactor was inerted and the mixture was cooled to 20° C.

Aqueous NaOH (50%, 60.92 g) was slowly added to the reactor through the addition funnel, maintaining the mixture slurry temperature at 20° C. The reaction mixture was held for 1 hour at 20° C. after the caustic addition was completed.

Aqueous NaOH (50%, 36.37 g) was slowly added to the reactor through the addition funnel, maintaining the mixture slurry temperature at 20° C. The reaction mixture was held for 5 minutes at 20° C. after the caustic addition was completed. Monochloroacetic acid (MCA, 42.91 g) was added to the reactor through an open reactor port, maintaining a reactor slurry temperature of 20° C. After MCA addition was completed, the reaction slurry was heated to 70° C. and held for 1.5 hours. 1.6 ml of 6% H₂O₂ was added to the reactor and the slurry was heated at 70° C. for 30 minutes. The reaction slurry was filtered and the resulting wet cake was washed three times with 565 g of 80% aqueous methanol and one time with 1000 g of pure methanol. The resulting wet cake was broken into small particles and dried in a fluidized bed dryer for 35 minutes. (Air-dry for 5 minutes, heat-dry at 50° C. for 10 minutes, and heat-dry at 70° C. for an additional 20 minutes.) The product was ground in Retsch Grinding Mill using a 1 mm screen. Degree of Substitution (DS)=0.62. 1% aqueous viscosity=2200 cps.

### Example 10

Isopropyl alcohol (IPA, 713.86 g) and deionized (DI) water (73.79 g) were charged into a jacketed resin kettle reactor equipped with an air driven stirrer, stainless steel agitator, a pressure equalizing addition funnel, a reflux condenser, vacuum, nitrogen inlet and a thermocouple. A cellulose pulp (65.0 g, 3.7% moisture) was added to the reactor, the reactor was sealed, and the agitator was adjusted to obtain good mixing. The reactor was inerted and the mixture was cooled to 20° C.

Aqueous NaOH (50%, 39.98 g) was slowly added to the reactor through the addition funnel, maintaining the mixture slurry temperature at 20° C. The reaction mixture was held for 1 hour at 20° C. after the caustic addition was completed.

Aqueous NaOH (50%, 35.77 g) was slowly added to the reactor through the addition funnel, maintaining the mixture slurry temperature at 20° C. The reaction mixture was held for 5 minutes at 20° C. after the caustic addition was completed. Monochloroacetic acid (MCA, 42.25 g) was added to the reactor through an open reactor port, maintaining a reactor slurry temperature of 20° C. After MCA addition was completed, the reaction slurry was heated to 70° C. and held for 1.5 hours. The reaction slurry was filtered and the resulting wet cake was washed three times with 565 g of 80% aqueous methanol and one time with 1000 g of pure methanol. The resulting wet cake was broken into small particles and dried in a fluidized bed dryer for 35 minutes. (Air-dry for 5 minutes, heat-dry at 50° C. for 10 minutes, and heat-dry at 70° C. for an additional 20 minutes.) The product was ground in Retsch Grinding Mill using a 1 mm screen. Degree of Substitution (DS)=0.84. 1% aqueous viscosity=3760 cps.

### Example 11

This Example illustrates the behavior of the preparations of a 1.0% CMC samples of the present invention in a 6.0 M urea solution.

The 1% CMC solution was prepared in the following equipment:

Caframo RZR1 overhead stirrer, 8-oz. glass jars, stainless steel stirring shaft with two 3-blade propellers (1.5 inch diameter), Parafilm®, deionized (DI) water, Germaben II.

A 0.50% Germaben solution was prepared by adding the Germaben II to DI water. This solution was then weighed into an 8-oz. glass jar. The solution was then stirred with an overhead stirrer, while the CMC was quickly added to the solution. The CMC level is 1.0% of the final sample weight. CMC weight is corrected for moisture content. As the viscosity begins to increase, the speed of the stirrer was increased to the maximum rate that does not cause splashing out of the sample. The jar is covered with Parafilm while mixing to prevent evaporation of water and loss from splashing. The sample is stirred for one hour. After one hour of stirring at the highest rate, the stirring speed was decreased to a setting of 4 for one additional hour. The sample was centrifuged for approximately 5 minutes to remove trapped air.

The behavior of the samples were studied in the following equipment:

Caframo RZR1 overhead stirrer, 8-oz. glass jars, stainless steel stirring shaft with two 3-blade propeller (1″ diameter), Parafilm®, 6.0M Urea (180.18 g urea diluted to 500 ml)

Procedure:

6.0M urea solution was weighed into an 8-oz. glass jar. The solution was stirred with an overhead Caframo RZR1 stirrer, as the CMC was quickly added to the solution. The CMC level was 1.0% of the final sample weight. CMC weight was corrected for moisture content. As the viscosity begins to increase, the speed of the stirrer was increased to the maximum rate that does not cause splashing out of the sample. The jar was covered with Parafilm while mixing to prevent evaporation of water and loss from splashing. The sample was stirred for one hour. After one hour of stirring at the highest rate, the stirring speed was decreased to a setting of 4 for one additional hour. The sample was centrifuged for approximately 5 minutes to remove trapped air.

TABLE 1

| | | 1% | 1% | |
|---|---|---|---|---|
| | | Dynamic | Dynamic | |
| | | Water | 6M Urea | Relative |
| CMC | DS | viscosity | viscosity | U/W ratio |
| Example 8 | 0.73 | 1113 | 1364 | 0.78 |
| Example 1 | 0.89 | 574 | 632 | 0.70 |
| Example 2 | 0.87 | 238 | 288 | 0.77 |
| Example 7 | 0.79 | 762 | 539 | 0.45 |
| Example 5 | 0.86 | 265 | 338 | 0.81 |
| Example 3 | 0.79 | 286 | 355 | 0.79 |
| Example 4 | 0.78 | 346 | 398 | 0.73 |
| Example 6 | 0.86 | 163 | 228 | 0.89 |
| Aqualon 7LF | 0.81 | 11 | 16 | 0.97 |
| Aqualon 7LF | | 11 | 17 | 0.96 |
| Aqualon 7L | 0.79 | 9 | 14 | 0.97 |
| Aqualon 7H3SF | 0.97 | 7191 | 12754 | 1.13 |
| Aqualon 7H3SF | 0.92 | 2286 | 4179 | 1.16 |
| Aqualon 7H3SF | 0.88 | 7337 | 13258 | 1.15 |
| Aqualon 7H3XSF | 0.89 | 3262 | 5909 | 1.15 |
| Aqualon 7H3SXF | | 3111 | 4950 | 1.01 |
| Aqualon 7HF | 0.86 | 7023 | 11648 | 1.05 |
| Aqualon 7H4F | 0.77 | 4875 | 8576 | 1.12 |
| Aqualon 7M8SF | | 68 | 111 | 1.03 |
| Aqualon 9M31F | 0.9 | 260 | 467 | 1.14 |
| Aqualon 9M31F | 0.92 | 577 | 1065 | 1.17 |
| Aqualon 9M31F | 0.9 | 539 | 823 | 0.97 |
| Aqualon 9M31XF | | 282 | 470 | 1.06 |
| Amtex | | 168 | 282 | 1.07 |
| Antisol FL | | 2852 | 8510 | 1.90 |
| 300000 | | | | |
| Aqualon | | 7795 | 12583 | 1.03 |
| Aquapac | | | | |
| Aqualon | | 11446 | 19881 | 1.10 |
| Aquapac | | | | |
| DKS Cellogen | | 100 | 179 | 1.14 |
| HE-90 | | | | |
| DKS Cellogen | | 4417 | 8154 | 1.17 |
| HP-5HS | | | | |
| Fine Gum SA-H | | 463 | 1016 | 1.40 |
| Monpac Regular | | 2755 | 5980 | 1.38 |
| Noviant Cekol | | 47 | 68 | 0.92 |
| 500T | | | | |
| Noviant Cekol | | 53 | 96 | 1.16 |
| 700 | | | | |
| Noviant Cekol | | 139 | 246 | 1.13 |
| 2000 | | | | |
| PAC-R | | 7335 | 11798 | 1.02 |
| Tylopur C1000 | | 316 | 558 | 1.12 |
| P2 | | | | |
| Walocel CRT | | 180 | 285 | 1.01 |
| 2000 | | | | |

### Example 12

Dynamic viscosities were measured using at 25° C. using an RFS III strained controlled rheometer by Rheometrics using a 40 mm parallel tool geometry with the gap set at 2 mm. The samples were pre-sheared at 100 s⁻¹ for 60 second upon loading to erase the loading history. The pre-shearing was followed by the steady shear experiment between 0.01 and 100 s⁻¹. Each point data is the average of clockwise and counter-clockwise rotations each with the duration of 20 sec. All samples exhibited a low shear Newtonian plateau, the average of which was used in the data analysis and further comparisons. The dynamic viscosities of the aqueous and 6M 1% CMC solutions are summarized in Table 1. The relative urea/water ratios are also summarized in Table 1, above.

### Example 13

The CMC's of the present invention exhibit enhanced thickening capabilities and syneresis control in toothpaste formulations. Calcium Carbonate Based Toothpaste formulation:

| Ingredient: | wt. % |
|---|---|
| Calcium carbonate | 45.00 |
| Sorbo ® sorbitol (70% solids) | 27.00 |
| Distilled water | 23.97 |
| CMC Polymer (Table 2) | 0.60 |
| Sodium lauryl sulfate, 100% active powder | 1.00 |
| Sodium monofluorophosphate | 0.76 |
| Sodium benzoate | 0.50 |
| Flavor | 0.55 |
| Tetra sodium pyrophosphate | 0.42 |
| Sodium saccharin | 0.20 |
| | 100.00 |

Standard laboratory toothpaste preparation was performed. Salts were first dissolved in part of the water and warmed for complete dissolution. The CMC was dispersed in the sorbitol, using an overhead mixer with a propeller attachment. After the CMC was well dispersed, the balance of the water was added with continued mixing until the CMC appeared dissolved. The warm salt solution was mixed into the CMC solution. This was then transferred to a 1-quart Ross double planetary mixer. The calcium carbonate was then stirred in the mixer, and after it was well dispersed, a vacuum was applied. After mixing under vacuum for 20 minutes, the sodium lauryl sulfate was mixed in without vacuum.

The flavor was mixed in the same way. After all formula components were together, the mixture was mixed under vacuum for 15 minutes at high speed. The batch was then packed into 2-oz. jars and 6-oz. toothpaste tubes.

Toothpaste samples were stored for 30 days at room temperature. Samples were equilibrated in a 25° C. water bath for 4 hours prior to any tests conducted.

Viscosity was measured using a Brookfield DV-I fitted with a T-bar style spindle. A helipath stand was used to allow the spindle to sweep downward through the sample to prevent the effects of shear. Viscosity was taken every 30 seconds over 2 minutes and values were averaged.

Toothpaste consistency was measured using a rack test. The rack designed with cross bars of increasing distance apart left to right. The toothpaste tube containing the sample to be measured is fitted with a stainless orifice fitting to eliminate differences in orifice size that may occur. The tube is squeezed in a uniform manner across the rack, extruding the paste onto the rack in a ribbon. After 15 seconds it is recorded at which opening the ribbon has fallen through the opening and broken. The opening number from left to right is the value recorded as a “Cuban” value.

The toothpaste data are summarized in Table 2.

TABLE 2

| | 30 day | | |
|---|---|---|---|
| | Toothpaste | | |
| Polymer | Viscosity | Cuban | Comments |
| Example 2 | 137500 | 5 | |
| Example 1 | 188125 | 10 | |
| Example 3 | 146750 | 6 | |
| Example 4 | 136250 | 6 | |
| Example 5 | 120000 | 5 | |
| Example 6 | 94500 | 3 | |
| Example 7 | 125750 | 5 | |
| Cekol 500T | 61875 | 2 | |
| Cekol 2000 | 25875 | 0 | severe |
| | | | syneresis |
| 9M31XFGL | 40125 | 0 | syneresis |
| 9M31F | 32500 | 0 | syneresis |

### Example 14

The CMC's of the present invention in combination with other polymers exhibit decreased post thickening and structure build and enhanced initial structure in toothpaste formulations.

Viscosity is one measure of post-thickening in toothpaste. Toothpaste samples were packed into vials and the viscosity was measured using a Brookfield DV-I fitted with a T-bar style spindle. A helipath stand was used to allow the spindle to sweep downward through the sample to prevent the effects of shear. Viscosity was taken every 30 seconds over 2 minutes and values were averaged

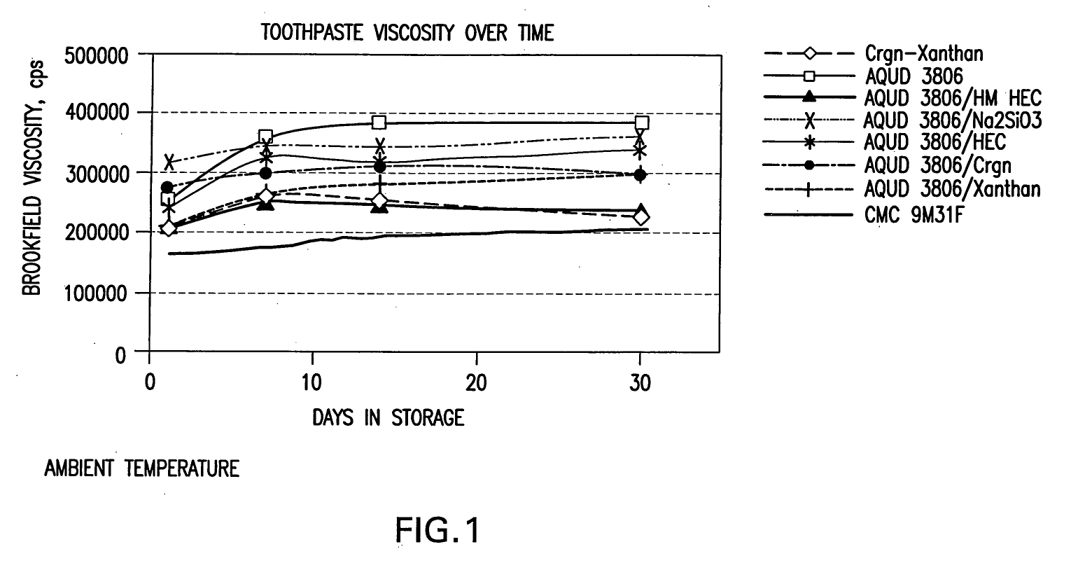

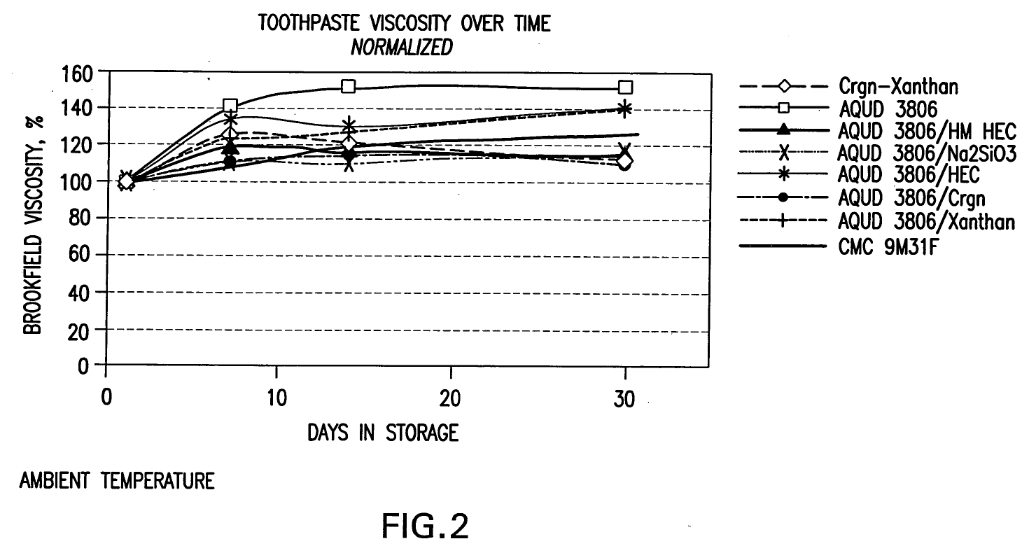

It can be seen from the data in the graph (FIG. 1) that most samples exhibited a change in viscosity from the first day after processing through 30 days. When the data are normalized to the initial viscosity as 100%, the change over time is more apparent (FIG. 2). Toothpaste made with combinations of Example 7 CMC with other polysaccharides or inorganic salts exhibited lower post-thickening compared to toothpaste made with Example 7 alone.

Toothpaste structure is also an important aspect. This property may be measured by force required for compression using a MTS Servo Hydraulic test system from MTS Systems Corporation, Minneapolis, Minn. The instrument was fitted with a half-inch acrylic cylinder probe, toothpaste samples were packed into vials after processing and measured directly without disturbance.

It can be seen below in Table 3 that the Example 7 CMC alone or with other polysaccharides or inorganic salt produced toothpaste of similar or greater initial structure compared to toothpaste made with carrageenan and xanthan and much greater initial structure than toothpaste made with commercial CMC 9M31F.

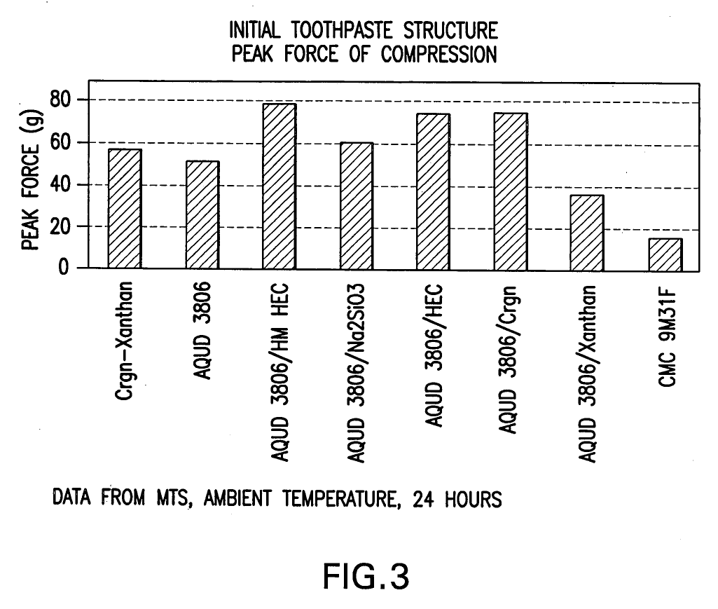

Peak force of compression was monitored over 30 days. It was found that most samples changed in values (FIG. 3). The comparison can be made more

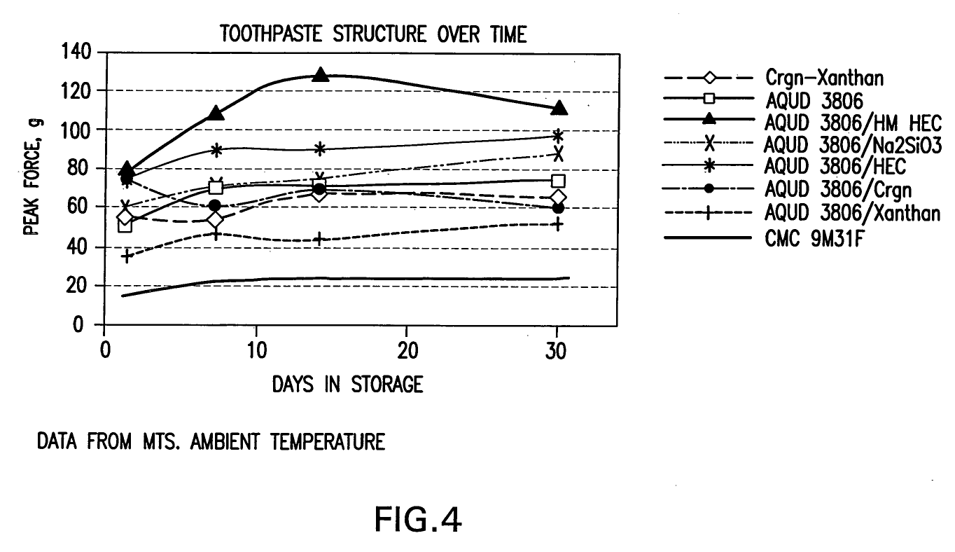

easily if the data are normalized to the initial structure value as 100% as shown in FIG. 4. From the normalized data of FIG. 4, it can be seen that toothpaste samples made with combinations of CMC of Example 7 with other polysaccharides or inorganic salt have lower structure build over time.

From the work outlined here, it can be concluded that toothpaste with high structure and low post-thickening can be made with CMCs of the present invention in combination with other polysaccharides, inorganic salts or combinations thereof.

The toothpaste formulation used in this Example was as follows:

| Ingredient | Wt. % |
|---|---|
| Sorbitol (Sorbo) | 29.2 |
| Glycerine | 6 |
| PEG 400 | 3 |
| Sident 9 | 14 |
| Sident 22S | 16 |
| Sodium Saccharine | 0.20 |
| Sodium Monofluorophosphate | 0.23 |
| Sodium Benzoate | 0.20 |
| Sodium Lauryl Sulfate | 1.20 |
| Flavor | 0.50 |
| Water | q.s. |

The different polymers used in this Example in the formulation was as follows:

| Formulation | Polymer: | wt % | Polymer: | wt % |
|---|---|---|---|---|
| 1 | Carrageenan (THP1) | 0.7 | Xanthan (Rhodicare) | 0.3 |
| 2 | CMC Example 7 | 1.0 | N/A | |
| 3 | CMC 9M31F | 1.0 | N/A | |
| 4 | CMC Example 7 | 0.5 | Natrosol + 330 | 0.3 |
| 5 | CMC Example 7 | 0.6 | Natrosol 250 M | 0.6 |
| 6 | CMC Example 7 | 0.7 | Carrageenan | 0.3 |
| 7 | CMC Example 7 | 1.0 | Sodium Silicate | 0.5 |
| 8 | CMC Example 7 | 0.7 | Xanthan | 0.3 |

TABLE 3
Initial Toothpaste Structure
Peak Force Compression from MTS

| | Peak Force |
|---|---|
| Polymer | Compression, g |
| Carageenan/Xanthan | 56.5 |
| Example 7 | 51.1 |
| Example 7/HMHEC | 78.1 |
| Example 7/Na₂SiO₃ | 60.8 |
| Example 7/HEC | 75.1 |
| Example 7/Carrageenan | 75.3 |
| Example 7/Xanthan | 35.0 |
| CMC 9M31 F | 14.7 |

Toothpaste after 24 hours, ambient temperature.

The identity and supplier of the ingredients of this Example are as follows:

| | |
|---|---|
| Sorbitol | Sorbo, 70%, USP/FCC, SPI Pharma, |
| | New Castle, DE, USA |
| Glycerine | Glycerine, USP, Spectrum Chemical, |
| | Gardena, CA, USA |
| PEG 400 | Polyethylene Glycol NF, Dow Chemical, |
| | Midland, MI, USA |
| Silica, thickening | Sident 9, Degussa, Frankfurt, Germany |
| Silica, abrasive | Sident 22S, Degussa, Franfurt, Germany |
| Sodium Lauryl Sulfate | Stepan, Northfield, IL, USA |
| Flavor | Fresh Mint, Givaudan, UK |
| Sodium Silicate, crystalline | JT Baker, reagent grade |
| Sodium Benzoate | Fisher Scientific, reagent grade |
| Saccharine | Sigma, reagent grade |
| Sodium Fluorophosphate | Alfa Aesar, Ward Hill, ME, USA |
| Carrageenan | THP1, CP Kelco, San Diego, CA, USA |
| Xanthan | Rhodicare S, Rhodia, Cranbury NJ, USA |
| CMC 9M31F | Aqualon |
| HM HEC Natrosol Plus | Aqualon |
| 330 CS | |
| HEC Natrosol 250 M Pharm | Aqualon |

### Example 15

The CMC's of the present invention exhibit enhanced thickening capabilities in beverage formulations.

### Beverage Example

Orange Beverage—Reference

| Ingredients | Wt % |
|---|---|
| Orange Juice concentrate, 45 Brix | 7.00 |
| Sugar | 40.00 |
| Citric acid | 0.05 |
| Sodium benzoate | 0.55 |
| Water | 52.14 |
| Cellulose Gum, CMC-9M31F | 0.60 |

### Orange Beverage—Test Example

| Ingredients | Wt % |
|---|---|
| Orange Juice concentrate, 45 Brix | 7.00 |
| Sugar | 40.00 |
| Citric acid | 0.05 |
| Sodium benzoate | 0.55 |
| Water | 52.14 |
| Polymer Example 7 | 0.42 |

Mix cellulose gum or polymer into water, allow to mix for 20 minutes. Premix acid, preservative and sugar, add and mix 5 minutes. Add juice concentrate, mix 3 minutes.

| Beverage results: | Reference | Test Example |
|---|---|---|
| Viscosity, 24 hours, cps | 53.0 | 51.0 |
| Brookfield LV, spindle 2, 30 rpm, 20 s | | |

### Example 16

The CMC's of the present invention exhibit enhanced thickening capabilities in food formulations.

### Cake Mix and Cake Example

Cake Mix—Reference

| Ingredients for Dry Mix | % Flour wt | Wt % of dry mix |
|---|---|---|
| Bleached Cake Flour | 100 | 40.4 |
| Sugar | 105.9 | 42.2 |
| Shortening | 27.2 | 11.0 |
| Milk Solids Nonfat | 3.7 | 1.5 |
| Dextrose⁽¹⁾ | 2.5 | 1.0 |
| Salt | 2.5 | 1.0 |
| Sodium Bicarbonate⁽²⁾ | 2.2 | 0.9 |
| Sodium aluminum phosphate⁽³⁾ | 1.2 | 0.9 |
| Vanilla Powder⁽⁴⁾ | 1.2 | 0.5 |
| Butter Flavor⁽⁵⁾ | 0.3 | 0.1 |
| Cellulose Gum, CMC-7HF | 1.2 | 0.5 |

### Cake Mix—Test Example

| | % Flour | Wt % of |
|---|---|---|
| Ingredients for Dry Mix | wt | dry mix |
| Bleached Cake Flour | 100 | 40.4 |
| Sugar | 105.9 | 42.2 |
| Shortening | 27.2 | 11.0 |
| Milk Solids Nonfat | 3.7 | 1.5 |
| Dextrose⁽¹⁾ | 2.5 | 1.0 |
| Salt | 2.5 | 1.0 |
| Sodium Bicarbonate⁽²⁾ | 2.2 | 0.9 |
| Sodium aluminum phosphate⁽³⁾ | 1.2 | 0.9 |
| Vanilla Powder⁽⁴⁾ | 1.2 | 0.5 |
| Butter Flavor⁽⁵⁾ | 0.3 | 0.1 |
| Polymer Example 9 | 0.72 | 0.3 |

⁽¹⁾Arm & Hammer Baking Soda, Church & Dwight
⁽²⁾Cantab Dextrose, Penford Food Ingredient Company
⁽³⁾Levair, FCC Grade Sodium Aluminum Phosphate, Rhodia Food Ingredients
⁽⁴⁾Vanilla FL Pure Pwd K, Virginia Dare
⁽⁵⁾Butter FL N&A Pwd 685 KD, Virginia Dare

Formulation for the Finished Cake - One 8-inch Layer

| | |
|---|---|
| Dry mix, g | 270 |
| Water, g | 140 |
| Whole egg, g | 53 |

Dry ingredients were blended on mixer with paddle attachment until evenly mixed. Water and egg were added to mix and mixed on medium speed for 3 minutes. The batter was poured into a greased cake pan and baked in a moderate oven (350° F./177° C.) for 30 minutes.

| Cake results: | Reference | Test Example |
|---|---|---|
| Batter Viscosity, cps | 5660 | 7650 |
| Brookfield RV, spindle 3, 10 rpm, 30 s | | |
| Batter density, g/100 mls | 111 | 113 |
| Cake height, cm | 3.8 | 3.8 |
| Crumb cell structure | even | even |
| Bake out | OK | OK |
| Crumb moisture, 24 hours after bake, % | 39.0 | 39.0 |

### Example 17

The CMCs of the present invention exhibit efficiency by the use of reduced amounts but yet obtain corporate results with prior art materials. The film forming and viscosity properties are enhanced in food preparations.

### Masa and Corn Tortilla Example

MASA—Reference

| | % Flour | Wt % of |
|---|---|---|
| Ingredients for Dry Mix | wt | dry mix |
| NCF⁽¹⁾ | 100 | 98.83 |
| Sodium Benzoate | 0.4 | 0.39 |
| Fumaric Acid | 0.3 | 0.29 |
| Cellulose Gum, CMC-7H4F K | 0.5 | 0.49 |

### MASA—Test Example

| | % Flour | Wt % of |
|---|---|---|
| Ingredients for Dry Mix | wt | dry mix |
| NCF⁽¹⁾ | 100 | 98.63 |
| Sodium Benzoate | 0.4 | 0.39 |
| Fumaric Acid | 0.3 | 0.29 |
| Polymer Example 10 | 0.3 | 0.29 |

⁽¹⁾Nixtamalized corn flour, Quaker Oats Company

Dry ingredients were blended on mixer with paddle attachment until evenly mixed. Water was added to mix and mixed on medium speed for 2 minutes. Dough was portioned into 50 g balls and pressed on a tortilla press. The tortillas were baked on an ungreased skillet for 1 minutes on each side. Tortillas were cooled on a wire rack, wrapped in foil sheets and checked for pliability and reheat after 1 day.

| Tortilla results: | Reference | Test Example |
|---|---|---|
| Appearance after bake | even blisters | even blisters |
| Pliability | good roll, no cracks | good roll, no cracks |
| Reheat | good puff | good puff |

### Example 18

The CMC's of the present invention exhibit enhanced tablet crushing strength without effecting drug release kinetics.

The following formulations were prepared:

| | Total batch size | 1500 g |
|---|---|---|
| | | 3750 Tablets |
| Material | % | Wt per Tab (Mg) |
| Example 7 | 7.5 | 30 |
| Klucel HXF | 22.5 | 90 |
| Phenylpropanolamine | 20.0 | 80 |
| Avicel PH101 | 49.5 | 198 |
| Magnesium Stearate | 0.5 | 2 |
| Example 7 | 7.5 | 30 |
| Natrosol 250 HX | 22.5 | 90 |
| Theophylline | 20.0 | 80 |
| Avicel PH101 | 49.5 | 198 |
| Magnesium Stearate | 0.5 | 2 |
| CMC 12M8 PH | 7.5 | 30 |
| Klucel HXF | 22.5 | 90 |
| Phenylpropanolamine | 20 | 80 |
| Avicel PH101 | 49.5 | 198 |
| Magnesium Stearate | 0.5 | 2 |
| CMC 12M8 PH | 7.5 | 30 |
| Natrosol 250 HX | 22.5 | 90 |
| Theophylline | 20 | 80 |
| Avicel PH101 | 49.5 | 198 |
| Magnesium Stearate | 0.5 | 2 |

Experimental Procedures:

All ingredients were sieved through a 20 mesh screen. All ingredients except magnesium were then dry blended in a 4 quart low shear Hobart mixer for 2 minutes. Thereafter water was added at a rate of 100 g/min while using low speed stirring. A total of 500 ml per 1500 g of powder was added to the formulations containing Klucel. This was increased to 700 g for Natrosol containing formulations. The wet masses were tray dried at 60° C. down to less than 2% moisture content. Following the drying step, the granulations were milled using the Fitzpatrick Comminutor Fitzmill at 2300 rpm, knives forward. The reduced granulation was then lubricated by addition of 0.5% magnesium stearate. This final mix was blended for 3 minutes in a V-blender.

Compactibility:

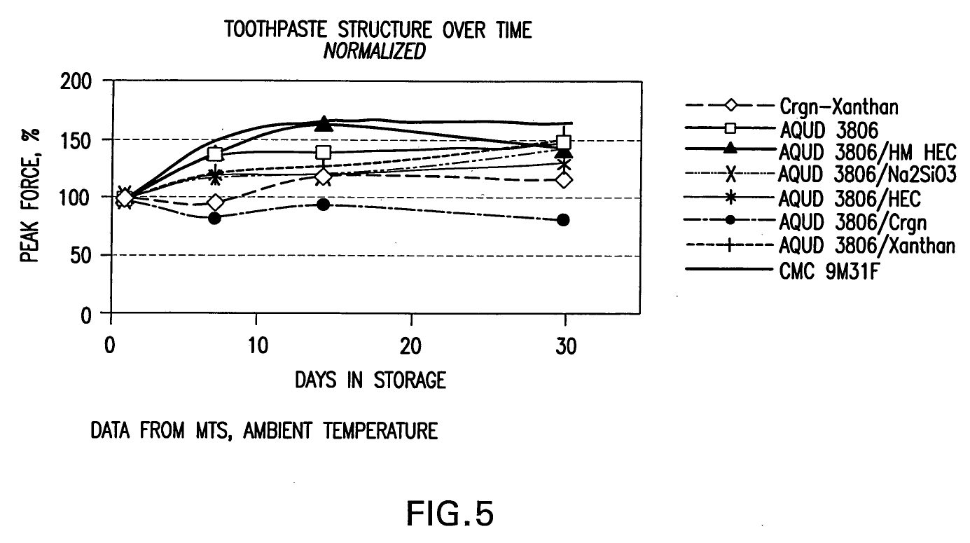

As shown in FIG. 5 for both model formulations, the inclusion of Example 7 CMC in place of CMC 12M8 pH in the tablet matrix results in a significant increase in tablet crushing strength.

Drug Release Kinetics

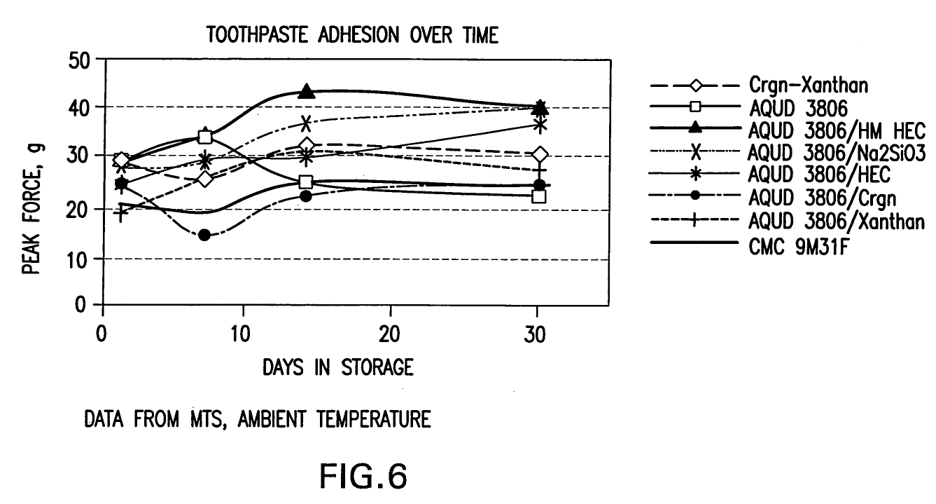

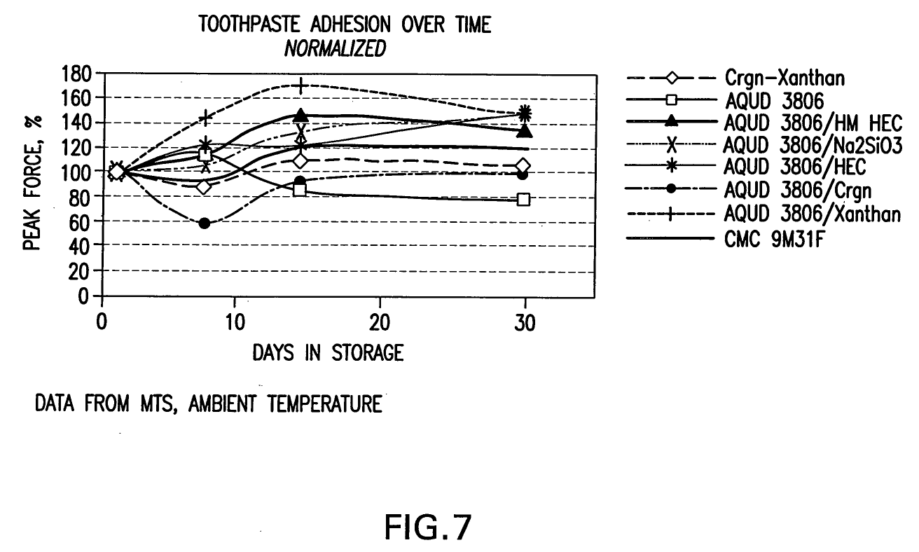

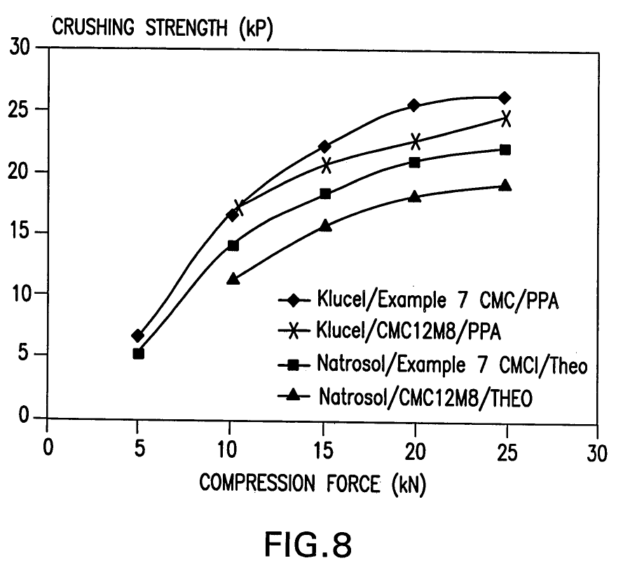

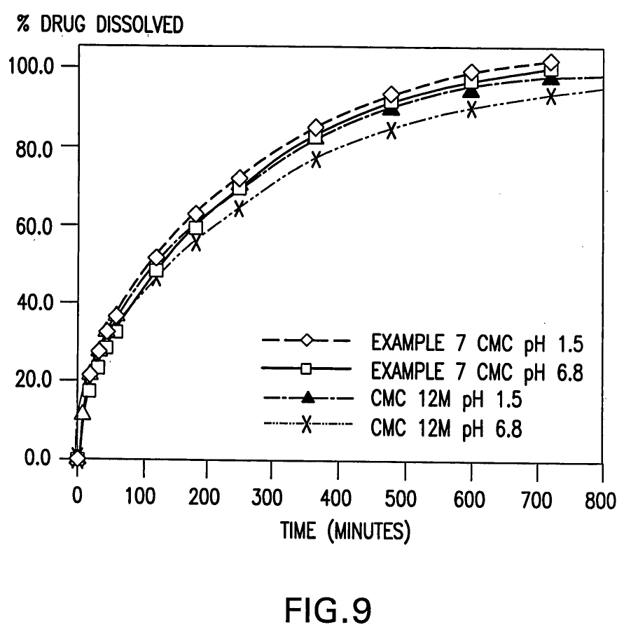

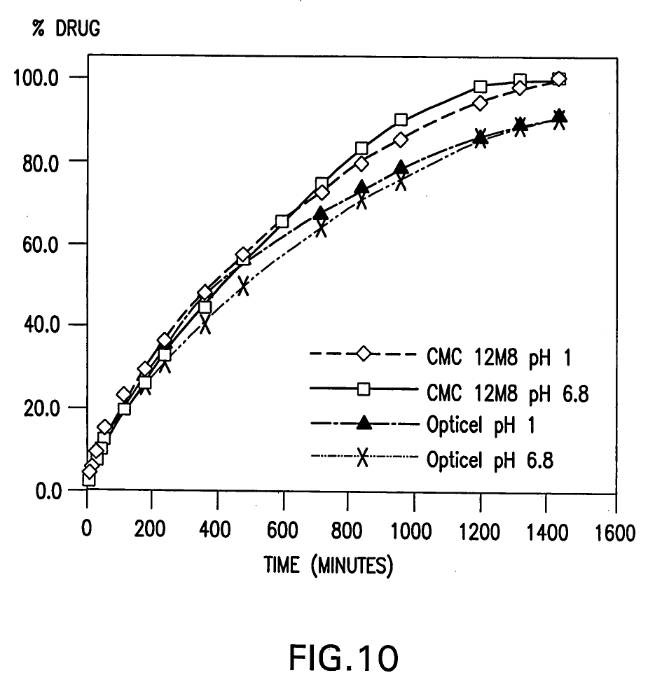

While compactibility is improved, inclusion of Example 7 CMC does not manifest in significant differences in the release kinetics when compared to 12M8 pH. This shown in FIGS. 6 and 7 for both highly soluble drug (phenylpropanolamine) and a sparingly soluble drug (Theophylline). Additionally no differences were evident at pH 1.5 or 6.8 between the Example 7 CMC and CMC 12M8 containing formulations.

### Example 19

The CMC's of the present invention exhibit enhanced thickening efficiency, enchanced high shear viscosity (ICI), improved spatter resistance and improved water resistance in paint formulations.

Model of an Interior Latex Flat Paint Based on Acronal 290 D.

| | Ingredients | Function | Parts by weight |
|---|---|---|---|
| Position | | | |
| 1. | Water | | 230.0 |
| 2. | Calgon N | wetting agent | 1.5 |
| 3. | Pigmentverteiler A | dispersing agent | 3.0 |
| 4. | CA 24 | preservative | 3.0 |
| 5. | Agitan 280 | defoamer | 5.0 |
| 6. | thickener | rheological modifier | variable |
| pre-mix | | | |
| 7. | Kronos 2057 | pigment | 198.0 |
| 8. | Omyalite 90 | extender | 140.0 |
| 9. | Durcal 5 | extender | 198.0 |
| 10. | Talcom AT 200 | extender | 28.0 |
| mill base | | | |
| 11. | Acronal 290 D | latex binder | 93.0 |
| 13. | butylglycol | coalescing agent | 20.0 |
| 14. | Texanol | | 5.0 |
| 15. | additional water | | 71.5 |
| let down | | | |
| PVC (%) | 80% | | |
| NVW (%) | 61% | | |

Suppliers:

2 Benckiser Knapsack GmbH

3 BASF AG

4 Biochema Schwaben—Dr. Lehmann & Co.

5 Munzing Chemie GmbH

6 Aqualon/HERCULES

7 Kronos Titan GmbH

8 Pluss Staufer SG

9 Pluss Staufer SG.

10 a/s Norwegian Talc

11 BASF AG

12 Shell Nederland Chemie BV

13 Eastman Chemicals

| | | | | | | | | Sag | | Water |
|---|---|---|---|---|---|---|---|---|---|---|
| | TE | Brookfield (20/4) | Stormer | Stormer | ICI | Levelling¹ | Leveling¹ | resistance | Spatter¹ | reten.² |
| Thickener | [wt %] | 24 hrs [mPa · s] | Initial [KU] | 24 hrs [KU] | [mPa · s] | Leneta | NYPC | [μm] | resistance | [mm] |
| BLANOSE ® 7M31C | 0.57 | 7050 | 98 | 106 | 125 | 5 | 0 | 600 | 2-3 | 4 |
| BLANOSE ® 7M31C | 0.46 | 6750 | 97 | 103 | 120 | 4 | 0 | 600 | 2-3 | 5 |
| BLANOSE ® 7M31C | 0.45 | 6500 | 97 | 104 | 150 | 2 | 0 | 550 | 3 | 4 |
| Example 7 CMC | 0.41 | 7550 | 97 | 107 | 150 | 1 | 0 | 600 | 4 | 3 |

Rating
¹0-10, 10 = BEST
²Water resistance test acc. Grimshaw; 0 mm = best

ICI Viscosity Determination: Determined using ASTM D4287-83

Krebs Stormer Viscosity Measurement: Determined using ASTM D 562

Levelling Leneta: Determined using ASTM D 4062-81

Levelling test NYPC: Determined using ASTM D 2801-69

Sag Resistance: Determined using ASTM D4400-84

Spatter Resistance—Roller:

The following equipment was used to evaluate the samples:

paint roller with synthetic fibers e.g. verfroller 15 cm art.nr. 32913 ex Van Vliet Kwastenfabriek

wall paper (woodchip quality) e.g. Erfurt Raufaser 52

Procedure:

About 200 grams of paint is taken up by the roller. Paint is applied on a woodchip wallpaper with dimensions 100×50 cm placed in vertical position. Paint is applied by ten-up and down strokes with the roller. A piece of black carch paper is placed horizontally 50 cm below the bottom line of the wallpaper. The amount of spatter that is intercepted on the black paper is compared to a series of reference charts rating from 1 to 10. A rating of 1 means severe spatter and a rating of 10 stands for completely spatter free.

Water Retention (According GRIMSHAW)

Equipment used in this part of the experment is:

Substrate: Whatman No.1 circular

Filter paper (diameter 12.5 cm)

Clamp ring inner diameter 7.7 cm outer diameter 12.6 cm

Pasteur pipette (poly ethylene disposable)

Colorant: Quink parket permanent block ink

Balance

Procedure

1. Mix a blend of paint/colorant thoroughly in an aluminum cup. Depending on the viscosity the following ratio's can be chosen:

| | |
|---|---|
| Paint:colorant | 50:50 |
| | 60:40 |
| | 75:25 |

Total amount 4-5 grams

2. Put the filter paper between two clamp rings and fix these with paper clips.

3. Weigh the clamped filter paper and apply with a Pasteur pipette 0.5 or 1.0 gram (depending the fluidity of the colored point blob) on the center of the filter paper.

4. Allow an overnight drying at room temperature.

5. Measure with a ruler the shaded stain round the paint center on 6 different spots.

6. The average expressed in mm is a measure for the water retention. A low value means a good water retention.

7. Report the used test conditions, ratio and amount of paint as well as the increase of the stain in mm.

While this invention has been described with respect to specific embodiments, it should be understood that these embodiments are not intended to be limiting and that many variations and modifications are possible without departing from the scope and spirit of this invention.

What is claimed:

1. A composition comprising carboxymethylcellulose (CMC) having a relative urea/water ratio of less than 0.9

2. The composition of claim 1, wherein the CMC has a relative urea/water ratio of less than 0.8

3. The composition of claim 1, wherein the CMC has associative and thixotrotropic properties.

4. A process for making a CMC comprising,
a) reacting in a slurry process, a source of cellulose, and about 40 to 80 wt % of the stoichiometric amount of NaOH for a sufficient time and at a sufficient temperature to form an alkali cellulose, and
b) adding to the alkali cellulose an amount of NaOH to bring the total amount of NaOH to about the stoichiometric level, and
c) immediately after step b, adding monochloroacetic acid to step b in a sufficient amount and reacting the slurry at a temperature and time sufficient to effect etherification in order to form the CMC product.

5. The process of claim 4, wherein the sufficient time and temperature to effect etherification is about 70° C. for about 1 to 2 hours.

6. The process of claim 4, wherein the CMC product is then cooled, any excess base is neutralized, washed, dried, and ground.

7. A CMC product prepared by the process of claim 4.

8. The CMC product of claim 7, wherein the product has a Degree of Substitution of from about 0.6 to about 1.2.

9. An aqueous rheology modifier system comprising the composition of claims 1 or 7.

10. A composition comprising the aqueous rheology modifier system of claim 9 as a vehicle component wherein the composition is selected from the group consisting of personal care, household care, paint, building material and construction, pharmaceutical, medical care, oilfield, mineral processing, paper making and paper coating, and food.

11. The composition of claim 10, wherein the composition is a personal care composition comprising (a) from about 0.1% to about 99.0% by weight of the vehicle component and (b) at least one active personal care ingredient.

12. The composition of claim 11, wherein the at least one active personal care ingredient is selected from the group consisting of deodorant, skin coolants, emollients, antiperspirant actives, moisturizing agents, cleansing agents, sunscreen actives, hair treatment agents, oral care agents, tissue paper products, and beauty aids.

13. The composition of claim 10, wherein the composition is a household care composition comprising (a) from about 0.1% to about 99.0% by weight of the vehicle component and (b) at least one active household care ingredient.

14. The composition of claim 13, wherein the at least one active household care ingredient is selected from the group consisting of industrial grade bar, gel and liquid soap actives, all purpose cleaning agents, disinfecting ingredient, rug and upholstery cleaning actives, laundry softeners actives, laundry detergent ingredients, dishwashing detergents, toilet bowl cleaning agents and fabric sizing agents.

15. The composition of claim 10, wherein the composition is a paint composition comprising a latex.

16. The composition of claim 15, wherein the paint composition also comprises a pigment.

17. The composition of claim 10, wherein the composition is a building material composition selected from the group consisting of joint compounds, mortars, concrete, caulking, and cement.

18. The composition of claim 10 wherein the composition is a pharmaceutical composition comprising an active drug.

19. The composition of claim 18, wherein the pharmaceutical composition is a sustained release system.

20. The composition of claim 10, wherein the composition is an oilfield composition selected from the group consisting drilling fluids and completion fluids.

21. The composition of claim 10, wherein the composition is a food composition selected from the group consisting of tortillas, cake mixes, bread mixes, bread, ice cream, sour cream, processed cheese spreads, cheese foods, and beverages.

22. The composition of claim 10, wherein the personal care composition is an oral care composition.

23. The composition of claim 22, wherein the oral care composition is a toothpaste or a denture adhesive.

24. A pharmaceutical composition in solid dosage form comprising the composition of claim 1 and a dry pharmaceutical active ingredient.

25. The composition of claim 24, wherein the composition of claim 1 functions as a binder or coating.

26. A blended composition comprising the composition of claim 1 and another water soluble or water swellable polymer.

27. An oral care composition comprising the composition of claim 26.

28. The blended composition of claim 26, wherein the polymer is selected from the group consisting of polysaccharides, biopolymers, synthetic polymers, and thickening silicas.

29. The blended composition of claim 28, wherein the polysaccharide is a nonionic, anionic, or cationic polymer selected from the group consisting of hydroxyethylcellulose (HEC), hydrophobically modified hydroxyethylcellulose (HMHEC), ethyl hydroxyethyl cellulose (EHEC), hydroxypropyl methyl cellulose (HPMC), hydroxyethyl methyl cellulose (HEMC), methylcellulose (MC) carrageenan, guar, hyaluronic acid, and glucosaminoglycan.

30. The blended compositoin of claim 28, wherein the biopolymer is xanthan gum.

31. The blended composition of claim 28, wherein the synthetic polymers are a nonionic, anionic, or cationic polymer selected from the group consisting of poly ethylene glycol, PEO-PPO, polyvinyl alcohol, polyacrylic acid, polyacrylates and co-polymers thereof, carbomer, and synthetic quats.
